(19) United States
(12) Patent Application Publication
(10) Pub. No.: US 2021/0312343 A1
(43) Pub. Date: Oct. 7, 2021

(54) Method for Parking a Vehicle

(71) Applicant: Daimler AG, Stuttgart (DE)

(72) Inventor: Bernd WOLTERMANN, Fellbach (DE)

(73) Assignee: Daimler AG, Stuttgart (DE)

(21) Appl. No.: 17/261,483

(22) PCT Filed: Jul. 1, 2019
(86) PCT No.: PCT/EP2019/067522

§ 371 Date: Jan. 19, 2021

(30) Foreign Application Priority Data
Jul. 20, 2018 (DE) 10 2018 005 761.6

(51) Int. Cl. G06Q 10/02; G01C 21/36; G08G 1/14; G07B 15/02; G06Q 50/30

(52) U.S. Cl. CPC G06Q 10/02; G01C 21/362; G06Q 50/30; G08G 1/148; G07B 15/02; G08G 1/144

(57) ABSTRACT

A method for parking a vehicle where travel data is transmitted to the vehicle by a communication between a personal mobile terminal of a user and the vehicle. The vehicle communicates with parking space providers taking the travel data into consideration where it ascertains parking space offers of the parking space providers and undertakes a prioritization of the parking space offers. The user or the vehicle selects one of the parking space offers. The vehicle reserves a parking space corresponding to the selected parking space offer and adopts the parking space as the destination of a navigation. A payment of parking space costs accrued is carried out by the vehicle.

### BACKGROUND AND SUMMARY OF THE INVENTION

The invention relates to a method for parking a vehicle.

A vehicle parking system and method for displaying and analyzing parking information are known from the prior art, as described in U.S. Pat. No. 9,177,475 B2. The system displays information about available parking spaces in the vicinity of a destination of a driver. It can provide personalized information, predictions and suggestions for a specific driver, since, over time, the system can learn the behavior of a specific driver.

A parking space management system and method are described in US 2017/0018183 A1. The system comprises a reservation server, which receives a reservation input, a parking confirmation input and a parking ending input from at least one user-client device, and a parking space status database in communication with the server and configures in order to allocate a status to each parking space in the database, the status being selected, in accordance with the input received from the server, from a group which contains as the status at least available, reserved and occupied.

The object of the invention is to specify a method for parking a vehicle that is an improvement on the prior art.

In a method for parking a vehicle, in particular for supporting a user, in particular a vehicle driver, to park the vehicle, travel data is transmitted to the vehicle by means of communication between a personal mobile terminal of the user and the vehicle. The mobile terminal of the user is, in particular, a mobile telephone, in particular a so-called smartphone.

According to the invention, the vehicle communicates with parking space providers, for example car park operators, in particular within a predetermined or predeterminable locality, for example, of a journey destination or intermediary destination, taking travel data into consideration, wherein the vehicle ascertains parking space offers from the parking space provider and undertakes a prioritization of the parking space offers. The travel data includes, for example, the journey destination or intermediary destination already mentioned, for example an airport or an event location, and for example terminal information, i.e., the travel data includes local and temporal information in particular.

The user or the vehicle selects one of the parking space offers. This means that, upon selection by the user, the vehicle presents the user with the parking space offers, for example, or a selection of the parking space offers, in particular in the prioritized order, for example in optical and/or acoustic form, for example on a display unit in the vehicle and/or on their mobile terminal, and the user selects one of the parking space offers.

Corresponding to the selected parking space offer, the vehicle reserves a parking space and assumes the parking space as the destination of a navigation. Payment of accrued parking space costs is carried out by the vehicle.

The method enables an efficiency increase and comfort increase since bothersome standard tasks, in particular, are carded out automatically by means of the method while parking the vehicle. Thus, client satisfaction of the user in relation to a manufacturer of the vehicle carrying out the method is increased. By means of the method, an optimum solution for the user in terms of parking the vehicle is achieved, in particular by the vehicle, in particular in conjunction with a respective journey destination of the user and date of the journey destination. Without the method according to the invention, when the user requires a parking space for their vehicle when reaching a respective journey destination, for example an event or an airport, in particular when they are in a rush, they would have to drive to the next-best car park, for example, and hope that there is a space and that it is not too expensive. After returning, in certain circumstances they have to pay any costs accrued before they can leave the car park. Using the method according to the invention, this is automated and, in addition, the optimum car park is selected or several car parks, in particular already pre-sorted by prioritization, are suggested to the user. Thus, it is ensured that the car park which the user then drives to has a space available, since it is reserved for the user, and that the costs are not too high, for example, and other conditions are also met, for example.

In particular, the vehicle can see the travel data in a diary of the user, which is stored in the personal mobile terminal of the user or to which the personal mobile terminal of the user has access. Thus, the vehicle ascertains a destination and/or intermediary destination, for example, and corresponding time data. In particular, the vehicle can deduce from this that the user will definitely, or at least with high probability, require a parking space, for example in a car park, for the vehicle, and where this parking space has to be located. Furthermore, the vehicle can deduce from this how much time the user will still need after parking the vehicle in order to reach an airplane on time, for example. The vehicle can also ascertain the dwelling time, for example, from the diary and thus retrieve the parking costs from the parking space providers and determine the total cost.

The prioritization of the parking space offers is carried out, for example, in terms of costs accruing, in particular car park costs, and/or in terms of safety and/or in terms of personal preference of the user and/or in terms of a route of the vehicle to the parking space and/or in terms of the period of time required for this and/or in terms of a time of day and/or a date and/or a weekday of arrival at the parking space and/or in terms of a dwelling time of the vehicle in the parking space and/or in terms of in terms of the time of day and/or date and/or weekday of the vehicle leaving the parking space and/or in terms of the weather, in particular in a period of time of arriving in the parking space and/or in a period of time of leaving the parking space and/or in a dwelling period of time, and/or in terms of a route of the user from the parking space to the destination and/or to an intermediary destination and/or in terms of a period of time required for this and/or in terms of the a required arrival time at the destination and/or at the intermediary destination and/or in terms of a return route of the user form the destination and/or intermediary destination to the parking space and/or in terms of a period of time required for this.

Advantageously, on the basis of this information, the vehicle ascertains the best possible parking space choice based on the situation and presents one or more corresponding parking space offers to the user, for example. The user can confirm the proposed best parking space offer or one of the proposed parking space offers, i.e., select it in order to have the corresponding parking space offer reserved by the vehicle, or the vehicle itself selects the best parking space offer and reserves the corresponding parking space offer without asking the user. Furthermore, the vehicle automatically assumes the parking space as the destination of the navigation, i.e., it correspondingly adjusts a navigation route and thus navigates to the parking space as the destination.

The personal preferences of the user mentioned above, which can be taken into consideration when prioritizing the parking space offers, are specified by the user, for example, and/or learnt by the vehicle, in particular with reference to previous parking processes of the user. When the user is specifying, they can actively decide which preferences are to be taken into consideration and which are not. By learning the preferences, the method can be optimized automatically and adjusted to the respective user.

For example, the vehicle transmits vehicle identification information, in particular a motor vehicle registration mark of the vehicle, to the parking space providers of the reserved parking space, in particular together with the reservation of the parking space. Thus, the vehicle can be automatically recognized and let in by the parking space provider, for example by the car park. The user stopping at an entrance barrier, for example, and detaching a parking ticket, for example, is thus not necessary, such that a further comfort increase is achieved.

For example, the vehicle communicates its leaving the parking space to the parking space provider of the reserved parking space, for example when the user returns and drives off in the vehicle. Since the payment of parking space costs accrued is also carried out by the vehicle, the user can leave the parking space and the car park, for example, in the vehicle without having to find a pay machine and/or stop at an exit barrier, such that a further comfort increase is hereby achieved.

The payment of parking space costs accrued by the vehicle is carried out for example by the vehicle communicating payment information required for this, in particular credit card information and/or debit information, to the parking space provider of the reserved parking space. Thus, an automatic renumeration can be carried out without engagement of the user being necessary for this.

The communication of the vehicle with the parking space providers and/or to obtain further information, in particular for prioritizing parking space providers can be carried out for example via the internet, i.e., via an internet connection of the vehicle, and/or by means of at least one other communication connection.

Exemplary embodiments of the invention are explained in more detail below by means of a drawing.

### BRIEF DESCRIPTION OF THE DRAWING

The FIGURE is a schematic depiction of a method for parking a vehicle.

### DETAILED DESCRIPTION OF THE DRAWING

The FIGURE shows a schematic depiction of a method for parking a vehicle 1, in particular for supporting a user 2 when parking the vehicle 1, wherein the user 2 is, in particular, a vehicle driver of the vehicle 1.

In this method, travel data is transmitted to the vehicle 1 by means of communication, depicted here schematically by means of a first communication arrow KP1, between a personal mobile terminal 3, in particular a mobile telephone formed as a smartphone, of the user 2 and the vehicle 1. The travel data includes, for example, a destination or intermediary destination, for example an airport or an event location, and, for example, appointment information, i.e., the travel data includes local and temporal information, in particular.

Schematically depicted here by second communication arrows KP2, the vehicle 1 communicates with parking space providers 4, for example with car park operators, taking the travel data into consideration, in particular in a predetermined or predeterminable locality, for example, of a journey destination or intermediary destination emerging from the travel data, wherein the vehicle 1 ascertains parking space offers from the parking space provider 4 and undertakes a prioritization of the parking space offers.

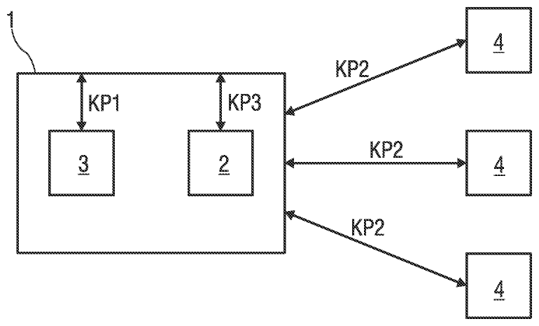

The user 2 or the vehicle 1 itself selects one of the parking space offers. That is to say, upon selection by the user 2, the vehicle 1 presents the user 2 with the parking space offers or a selection of the parking space offers, in particular in the prioritized sequence, for example in optical and/or acoustic form, for example on a display unit in the vehicle 1 and/or on their personal mobile terminal device 3, and the user 2 selects one of the parking space offers. This communication between the vehicle 1 and the user 2 is depicted schematically in FIG. 1 by a third communication arrow KP3.

Corresponding to the selected parking space offer, the vehicle 1 reserves a parking space and adopts the parking space as the destination of a navigation and thus navigates to the parking space as the destination. Payment of accrued parking space costs is carried out by the vehicle 1.

In particular, the vehicle 1 can see the travel data in a diary of the user 2, which is stored in the personal mobile terminal 3 of the user 2 or to which the personal mobile terminal 3 of the user 2 has access. Thus, the vehicle 1 ascertains a destination and/or intermediary destination, for example, and corresponding time data. In particular, the vehicle 1 can deduce from this that the user 2 will definitely, or at least with high probability, require a parking space, for example in a car park, for the vehicle 1, and where this parking space has to be located. Furthermore, the vehicle 1 can deduce from this how much time the user 2 will still need after parking the vehicle in order to reach an airplane on time, for example. The vehicle 1 can also ascertain the dwelling time, for example, from the diary and thus retrieve the parking costs from the parking space providers 4 and determine the total cost.

The prioritization of the parking space providers is carried out, for example, in terms of costs accruing, in particular parking space costs, and/or in terms of safety and/or in terms of personal preference of the user 2 learnt by the vehicle 1 and/or predetermined by the user 2 and/or in terms of a route of the vehicle 1 to the car park and/or in terms of the period of time required for this and/or in terms of a time of day and/or a date and/or a weekday of arrival at the parking space and/or in terms of a dwelling time of the vehicle 1 in the parking space and/or in terms of in terms of the time of day and/or date and/or weekday of the vehicle 1 leaving the parking space and/or in terms of the weather, in particular at a point in time or a period of time of arriving in the parking space and/or in a point in time or period of time of leaving the parking space and/or in a dwelling period of time, and/or in terms of a route of the user 2 from the parking space to the destination and/or to an intermediary destination and/or in terms of a period of time required for this and/or in terms of the required arrival time at the destination and/or at the intermediary destination and/or in terms of a return route of the user 2 from the destination and/or intermediary destination to the parking space and/or in terms of a period of time required for this.

For example, the vehicle 1 transmits vehicle identification information, in particular a motor vehicle registration number of the vehicle 1, to the parking space provider 4 of the reserved parking space, in particular together with the reservation of the parking space. Thus, the vehicle 1 can be automatically recognized and let in by the parking space provider 4.

For example, the vehicle 1 communicates its leaving the parking space to the parking space provider 4 of the reserved parking space, for example when the user 2 returns and drives off in the vehicle 1. Since the payment of parking space costs accrued is also carried out by the vehicle 1, the user 2 can leave the parking space in the vehicle and the car park, for example, without hindrance.

The payment of parking space costs accrued by the vehicle 1 is carried out for example by the vehicle 1 communicating payment information required for this, in particular credit card information and/or debit information, to the parking space provider 4 of the reserved parking space.

The communication of the vehicle 1 with the parking space providers 4 and/or to obtain further information, in particular for prioritizing parking space offers, can be carried out for example via the internet, i.e., via an internet connection of the vehicle 1, and/or by means of at least one other communication connection.

The method is described again below by means of an example. On the basis of the diary of the user 2, in particular the vehicle driver, known to the vehicle 1, in particular via the personal mobile terminal 3, and/or on the basis of a choice of a destination in a navigation system of the vehicle 1 by the user 2, the vehicle 1 knows that the user 2 will, in all likelihood, search for a parking space, for example in a car park. By means of the diary of the user, the vehicle 1 additionally knows an available time of the user 2, for example a time until a departure of a booked airplane and/or until check-in at the airport and/or until the start of an event.

By means of the internet, for example, the vehicle 1 can ascertain further information, for example a current dwelling time in a security check.

By means of the communication with the parking space providers 4, in particular via the internet, the vehicle 1 obtains, in particular via the parking space offers of the parking space provider 4, information about free parking spaces, for example in car parks, and costs accruing for this. Based on the travel data, in particular based on calendar information from the diary, the vehicle 1 can also calculate total costs to be expected.

Based on this information, the vehicle 1 calculates a best possible parking space choice based on the situation, in particular taking costs, time and, if applicable, also adjustable or learnt inclinations, i.e., preferences, of the user 2 as well as the weather, for example, and information about a journey form the parking space to the destination or intermediary destination, for example an event location, into consideration. The consideration of weather information is significant, for example, depending on whether or not the route from the car park to the destination or intermediary destination is sheltered.

The vehicle 1 presents the parking space to the user 2, i.e., the parking space offer, corresponding to the best possible car park choice based on the situation or a plurality of similarly good parking space offers. The user 2 can confirm the proposed parking space offer or can select and confirm the best parking space offer for them from the proposed selection.

The vehicle 1 reserves, in particular books, the parking space corresponding to the parking space offer selected and confirmed by the user 2 and correspondingly adjusts a navigation system route. Alternatively to the user 2 confirming, the vehicle 1 can also reserve, in particular book, the parking space corresponding to the best possible parking space offer without asking the user 2.

With the reservation, in particular booking, the vehicle 1 informs the parking space provider 4 whose parking space offer it has accepted, via the vehicle 1. It communicates vehicle identification information, in particular a motor vehicle registration number of the vehicle 1, such that the parking space provider 4 automatically admits the vehicle 1 without the user 2, in particular the vehicle driver, having to stop on entry, for example into the car park, and drawing a parking ticket, for example.

When the user 2 returns and departs in the vehicle 1, the vehicle 1 informs the parking space provider 4, for example the car park, in particular via its internet connection, about its departure, and communicates payment information to them, i.e., required payment information, for example credit card information, such that the user 2 can automatically leave the parking space and the car park, for example, in particular without an intermediary stop at a payment machine or a barrier.

1.-7. (canceled)

8. A method for parking a vehicle, comprising the steps of:
transmitting travel data to the vehicle by a communication between a personal mobile terminal of a user and the vehicle;
communicating by the vehicle with parking space providers taking the travel data into consideration;
ascertaining parking space offers of the parking space providers by the vehicle and undertaking a prioritization of the parking space offers by the vehicle;
selecting by the user or the vehicle one of the parking space offers;
reserving a parking space by the vehicle corresponding to the selected one of the parking space offers;
adopting the parking space by the vehicle as a destination of a navigation; and
paying of parking space costs accrued by the vehicle.

9. The method according to claim 8, wherein the vehicle sees the travel data from a diary of the user which is stored in the personal mobile terminal of the user or to which the personal mobile terminal of the user has access.

10. The method according to claim 8, wherein the prioritization of the parking space offers is carried out in terms of parking space costs and/or in terms of safety and/or in terms of a personal preference of the user and/or in terms of a route of the vehicle to a car park and/or in terms of a period of time to the car park and/or in terms of a time of day and/or a date and/or a weekday of arrival at the parking space and/or in terms of a dwelling time of the vehicle in the parking space and/or in terms of the time of day and/or date and/or weekday of the vehicle leaving the parking space and/or in terms of weather in a period of time of arriving in the parking space and/or in a period of time of leaving the parking space and/or in a dwelling period of time and/or in terms of a route of the user from the parking space to a second destination and/or to an intermediary destination and/or in terms of a period of time required for the route and/or in terms of a required arrival time at the destination and/or at the intermediary destination and/or in terms of a return route of the user from the destination and/or intermediary destination and/or in terms of a period of time required for the return route.

11. The method according to claim 8 further comprising the step of determining a personal preference of the user by a previous parking process of the user.

12. The method according to claim 8 further comprising the step of transmitting vehicle identification information by the vehicle to the parking space provider of the reserved parking space.

13. The method according to claim 8 further comprising the step of communicating leaving the parking space to the parking space provider of the reserved parking space by the vehicle.

14. The method according to claim 8, wherein the paying is performed by the vehicle communicating payment information to the parking space provider of the reserved parking space.

15. The method according to claim 14, wherein the payment information is credit card information or debit information.
